(19) United States
(12) Patent Application Publication
(10) Pub. No.: US 2010/0235084 A1
(43) Pub. Date: Sep. 16, 2010

(54) On-board car navigation destination search device and on-board car navigation destination search method

(75) Inventors: Norihisa Fujikawa, Okazaki (JP); Toyoji Hiyokawa, Okazaki (JP); Toru Sakai, Okazaki (JP)

Correspondence Address: OLIFF & BERRIDGE, PLC, P.O. BOX 320850, ALEXANDRIA, VA, 22320-4850, US

(73) Assignee: AISIN AW CO., LTD., ANJO-SHI (JP)

(21) Appl. No.: 12/585,200

(22) Filed: Sep. 8, 2009

(30) Foreign Application Priority Data
Oct. 31, 2008 (JP) 2008-282078

(51) Int. Cl. G01C 21/36

(52) U.S. Cl. 701/201

(57) ABSTRACT

Devices and methods search for a route from a departure point to a destination and provide guidance based on the route that is found. The devices and methods associate a street name with a parcel in which map data is associated with an area that is bounded by specified coordinates and, when the street name is input, extract the parcel in which the street name is located. The devices and methods extract a city area name in the extracted parcel and display the city area name such that the city area name can be selected. The devices and methods extract a local area name that is included in the parcel in which the selected city area name is located, display the local area name such that the local area name can be selected, and specify a house number within the parcel in which the selected local area name is located.

### INCORPORATION BY REFERENCE

The disclosure of Japanese Patent Application No. 2008-282078 filed on Oct. 31, 2008, including the specification, drawings and abstract is incorporated herein by reference in its entirety.

### BACKGROUND OF THE INVENTION

1. Field of the Invention

The present invention relates to an on-board car navigation destination search device and an on-board car navigation destination search method that guide a vehicle to a destination. In particular, the present invention relates to an on-board car navigation destination search device and an on-board car navigation destination search method that are compatible with a destination search in which the destination is set mainly on the basis of map information and little index information is used.

2. Description of the Related Art

Known on-board car navigation devices generally store the search data for a destination search separately from the corresponding map data. Even in a street address search and an intersection search, search data is created for the streets, the house numbers, secondary streets, and the like, to be searched, and the search function operates by referring to that search data.

A navigation device of this type is disclosed in Japanese Patent Application Publication No. JP-A-9-210715.

Navigation devices generally have region information that serves as an index for searching for a specific destination. For example, Japanese Patent Application Publication No. JP-A-9-210715 describes forms of index input and searching for a case in which the human user does not accurately remember the address.

Specifically, areas (sectors) within a region are stored in a storage medium in association with all or a part of an identification number that corresponds to the region, along with the locations, shapes, and names of the streets within each area. The inputting of one of all or a first part of a postal code and all or a first part of a telephone number allows the search area to be specified from the storage medium based on the number that is input. If the street names within an area are read and a specific street is selected from among the street names that are read, a map is displayed that includes the selected street. A number such as the postal code is used for specifying the area, and when the area is specified, a list of the streets within the area is presented. In these ways, the invention that is disclosed makes it easier to search for the destination.

### SUMMARY OF THE INVENTION

However, in addition to map information, that is, graphically represented map data and the corresponding information, navigation devices that have, as their search data, region information that serves as a search index for searching for a specific destination, and not only devices that use the technology in Japanese Patent Application Publication No. JP-A-9-210715, must also have information for various types of searches and must associate that information with the corresponding map data, such that the volume of information for searching becomes very large, and the amount of memory that is used increases accordingly.

For example, the invention that is disclosed in Japanese Patent Application Publication No. JP-A-9-210715 is presumed to be provided with a database of regions, locations, shapes, and names of streets, postal codes, telephone numbers, and the like, and the volume of information for searching therefore becomes very large, and the amount of memory that is used increases.

Thus, within the data for the navigation function, the amount of the search data increases, raising the possibility that the data cannot be stored in a storage medium that has a limited storage capacity, such as a CD, or a SD. The redundancy in such a large volume of data also leads to effects such as longer update times for the map database.

Accordingly, the present invention addresses these problems and provides an on-board car navigation destination search device that is capable of setting the destination by using map information, while reducing the amount of memory that is used for destination search indexing by limiting the indexing to a street name index.

An on-board car navigation destination search device according to a first aspect is a device in which a street search portion associates with a street name a parcel in which map data is associated with an area that is bounded by specified coordinates and, when the street name is input, to extract the parcel in which the street name is located; a first city area selection portion extracts a city area that is included in the parcel that was extracted by the street search portion and in which the street name is located, and displays the city area name such that it can be selected; a first local area selection portion extracts a local area name that is included in the parcel in which the city area name is located that was selected by the first city area selection portion, and displays the local area name such that it can be selected; and a house number selection portion specifies a house number within the parcel in which the local area name is located that was selected by the first local area selection portion.

The street search portion associates with the street name the parcel in which the map data is associated with the area that is bounded by the freely specified coordinates and, when the street name is input, extracts the parcel in which the street name is located.

The first city area selection portion extracts the city area that is included in the parcel that was extracted by the street search portion and in which the street name is located, and displays the city area name such that it can be selected.

The first local area selection portion extracts the parcel in which the city area name is located that was selected by the first city area selection portion, extracts the local area name that is included in the parcel, and displays the local area name such that it can be selected.

The house number selection portion extracts the parcel in which the local area name is located that was selected by the first local area selection portion, and displays the house number within the extracted parcel such that it can be selected.

Note that in a case where the present invention is practiced, the processing that is performed by the first city area selection portion, the processing that is performed by the first local area selection portion, and the processing that is performed by the house number selection portion may be performed in any order.

An on-board car navigation destination search device according to a second aspect is a device in which a street search portion associates with a street name a parcel in which map data is associated with an area that is bounded by specified coordinates and, when the street name is input, extracts the parcel in which the street name is located; a secondary street selection portion extracts a node name that is included in the parcel that was extracted by the street search portion and in which the street name is located, extracts a secondary street name that is associated with the node name, and displays the secondary street name such that it can be selected; a second city area selection portion extracts a city area name that is included in the parcel in which the node name is located that was selected by the secondary street selection portion, and displays the city area name such that it can be selected.

The street search portion associates with the street name the parcel in which the map data is associated with the area that is bounded by the freely specified coordinates and, when the street name is input, extracts the parcel in which the street name is located.

The secondary street selection portion extracts the parcel that was extracted by the street search portion and in which the street name is located, extracts the secondary street name that is included in the parcel, extracts the node name where the input street and the secondary street intersect, and displays the node name such that it can be selected.

The second city area selection portion extracts the parcel in which the node name is located that was selected by the secondary street selection portion, and extracts the specific city area name from the extracted parcel, and displays the city area name such that it can be selected, so the second city area selection portion is substantially the same as the first city area selection portion.

The second local area selection portion extracts the parcel in which the city area name is located that was selected by the second city area selection portion, and extracts the local area name that is included in the extracted parcel, and displays the local area name such that it can be selected, so the second local area selection portion is substantially the same as the first local area selection portion.

Note that in a case where the present invention is practiced, the processing that is performed by the secondary street selection portion and the processing that is performed by the second city area selection portion may be performed in any order.

An on-board car navigation destination search device according to a third aspect is a device in which a street search portion associates with a street name a parcel in which map data is associated with an area that is bounded by specified coordinates and, when the street name is input, extracts the parcel in which the street name is located; a node and city area selection portion extracts a city area name that is included in the parcel in which the street name is located that was extracted by the street search portion, extracts a node name that is included in the parcel that was extracted by the street search portion and in which the street name is located, extracts a secondary street name that is associated with the node name, and displays the city area name and the secondary street name such that they can be selected; when the secondary street name is selected by the node and city area selection portion, a node and local area selection portion extracts a city area name that is included in the parcel in which the secondary street name is located that was extracted by the node and city area selection portion, and displays the city area name such that it can be selected; when the city area name is selected by the node and city area selection portion, a local area and house number selection portion extracts a local area name that is included in the parcel in which the selected city area name is located, displays the local area name such that it can be selected, and specifies a house number within the parcel in which the selected local area name is located.

The street search portion associates with the street name the parcel in which the map data is associated with the area that is bounded by the any given specified coordinates and, when the street name is input, extracts the parcel in which the street name is located.

The node and city area selection portion extracts the node name that is included in the parcel in which the street name is located that was extracted by the street search portion and at which the street and the secondary street intersect, and displays the node name such that it can be selected. The node and city area selection portion also extracts the city area name that is included in the parcel in which the street name is located that was extracted by the street search portion, and displays the city area name such that it can be selected. Thus both the node name and the city area name can be selected.

When the node name is selected by the node and city area selection portion, the node and local area selection portion extracts the city area name that is included in the parcel in which the node name is located, displays the city area name such that it can be selected, extracts the local area name that is included in the parcel in which the city area name is located, and displays the local area name such that it can be selected.

Further, when the city area name is selected by the node and city area selection portion, the local area and house number selection portion extracts and displays the local area name that is included in the parcel in which the selected city area name is located, and specifies the house number within the parcel in which the selected local area name is located.

Note that in a case where the present invention is practiced, the processing that is performed by the node and city area selection portion, the processing that is performed by the node and local area selection portion, and the processing that is performed by the local area and house number selection portion may be performed in any order.

An on-board car navigation destination search method according to a fourth aspect associates with a street name a parcel in which map data is associated with an area that is bounded by specified coordinates, extracts the parcel in which the street name is located when the street name is input, extracts a city area name that is included in the parcel in which the street name is located, displays the city area name such that it can be selected, extracts a local area name that is included in the parcel in which the city area name is located, displays the local area name such that it can be selected, and specifies a house number within the parcel in which the local area name is located.

The extracting, when the street name is input, of the parcel in which the street name is located only needs to be able to extract the parcel in which the map data is associated with the area that is bounded by the specified coordinates by associating the parcel with the street name.

The extracting of the city area name that is included in the parcel in which the street name is located, and the displaying of the city area name such that it can be selected, only need to be able to extract and display the city area name that is included in the extracted parcel.

The extracting of the local area name that is included in the parcel in which the city area name is located, and the displaying of the local area name such that it can be selected, only need to be able to extract and display the local area name that is included in the extracted parcel.

Further, the specifying of the house number within the parcel in which the local area name is located only needs to be able to extract, display, and select the house number within the parcel in which the extracted local area name is located.

An on-board car navigation destination search method according to a fifth aspect associates with a street name a parcel in which map data is associated with an area that is bounded by specified coordinates, extracts the parcel in which the street name is located when the street name is input, extracts a node name that is included in the parcel in which the street name is located, extracts a secondary street name that is associated with the node name, displays the secondary street name that specifies the node name such that it can be selected, extracts a city area name that is included in the parcel in which the node name is located, displays the city area name such that it can be selected, extracts a local area name that is included in the parcel in which the city area name is located, and displays the local area name such that it can be selected.

The extracting, when the street name is input, of the parcel in which the street name is located only needs to be able to extract the parcel in which the map data is associated with the area that is bounded by the specified coordinates by associating the parcel with the street name.

The extracting of the node name that is included in the parcel in which the street name is located, along with the extracting of the secondary street name that is associated with the node name, and the displaying of the secondary street name that specifies the node name such that it can be selected, only needs to be able to extract and display the name of the intersecting secondary street that is associated with the node name that is included in the parcel in which the street name is located, and to be able to display the node name such that it can be selected. It is also obvious that the node name can be used directly, without using the secondary street name.

The extracting of the city area name that is included in the parcel in which the node name is located, and the displaying of the city area name such that it can be selected, only need to be able to extract and display the city area name that is included in the parcel in which the node name is located, and to be able to display the city area name such that it can be selected.

Further, the extracting of the local area name that is included in the parcel in which the city area name is located, and the displaying of the local area name such that it can be selected, only need to be able to display, such that it can be selected, the local area name from the parcel in which the city area name is located.

An on-board car navigation destination search method according to a sixth aspect associates with a street name a parcel in which map data is associated with an area that is bounded by specified coordinates, extracts the parcel in which the street name is located when the street name is input, extracts a city area name that is included in the extracted parcel, extracts a node name that is included in the parcel in which the street name is located, extracts a secondary street name that is associated with the node name, displays the city area name and the secondary street name such that they can be selected, extracts, when the secondary street name is selected, a city area name that is included in the parcel in which the secondary street name is located, displays the city area name such that it can be selected, extracts a local area name that is included in the parcel in which the selected city area name is located, displays the local area name such that it can be selected, extracts, when the city area name is selected, a local area name that is included in the parcel in which the city area name is located, displays the local area name being displayed such that it can be selected, and specifies a house number within the parcel in which the selected local area name is located.

The extracting, when the street name is input, of the parcel in which the street name is located only needs to be able to extract the parcel in which the map data is associated with the area that is bounded by the specified coordinates by associating the parcel with the street name.

The extracting of the node name where the input street and the secondary street intersect and the extracting of the city area that is included in the parcel in which the street name is located only need to be able to extract the secondary street name that is included in the parcel in which the street name is located, to extract the node name where the input street and the secondary street intersect that is included in the parcel, to display the node name such that it can be selected, to extract the city area name that is included in the parcel in which the input street name is located, and to display the city area name such that it can be selected.

When the node name is selected, the city area name that is included in the parcel in which the node name is located is extracted and displayed such that it can be selected, and the local area name that is included in the parcel in which the city area name is located is extracted and displayed such that it can be selected. Further, when the city area name is selected, the local area name that is included in the parcel in which the city area name is located is extracted and displayed, and the house number within the parcel in which the selected local area name is located is specified.

In the on-board car navigation destination search device according to any one of the first to the third aspects, the city area is one of a prefecture in the case of Japan and a state and an urban area in the case of the United States. In the on-board car navigation destination search method according to any one of the fourth to the sixth aspects, the city area is one of a prefecture in the case of Japan and a state and an urban area in the case of the United States.

In the on-board car navigation destination search device according to any one of the first to the third aspects, the local area is one of a county, a city, a town, and a village in the case of Japan, and a smaller city and a town area in the case of the United States. In the on-board car navigation destination search method according to any one of the fourth to the sixth aspects, the local area is one of a county, a city, a town, and a village in the case of Japan, and a smaller city and a town area in the case of the United States.

In the on-board car navigation destination search device according to the first aspect, index data for the destination search is created in advance by associating with the street name the parcel in which the map data is associated with the area that is bounded by the specified coordinates. The street search portion extracts the parcel in which the street name is located. The first city area selection portion extracts the city area name that is included in the selected parcel and displays the city area name such that it can be selected. The first local area selection portion extracts the local area name that is included in the parcel that was selected by the first city area selection portion and displays the local area name such it can be selected. The house number selection portion specifies the house number within the parcel that has been selected by the first local area selection portion, thus making it possible to specify an individual home.

At this time, it is possible to limit the index data for the destination search simply by associating with the street name the parcel in which the map data is associated with the area that is bounded by the specified coordinates. Because it is possible to search for the destination based on the information in the map data in addition to the index data, only as much memory as corresponds to the street name is used for the index data for the destination search. This reduces the amount of memory that is used for indexing and makes it possible to perform the destination search at low cost by using the map data. In particular, the map data includes a large amount of information in addition to the data required for the search, and if such map data is used for the search, the possibility arises that the search will be too slow. However, the present invention specifies the area called the parcel, which prevents the speed of the search from being slowed.

In the on-board car navigation destination search device according to the second aspect, index data for the destination search is created in advance by associating with the street name the parcel in which the map data is associated with the area that is bounded by the specified coordinates. The street search portion extracts the parcel in which the street name is located. The secondary street selection portion extracts the node name that is included in the parcel that was extracted by the street search portion and in which the street name is located, extracts the secondary street name that is associated with the node name, and displays, such that it can be selected, the secondary street name that specifies the node name. The second city area selection portion extracts the city area name that is included in the parcel that was selected by the secondary street selection portion and displays the city area name such that it can be selected. The second local area selection portion extracts the local area name that is included in the parcel that was extracted by the second city area selection portion and displays the local area name such that it can be selected, thus making it possible to specify an intersection (a node name) for which no house number is provided.

At this time, it is possible to create the index data for the destination search in which the house number is not specified, but the node name is specified, simply by associating with the street name the parcel in which the map data is associated with the area that is bounded by the specified coordinates. Because it is possible to select the destination based on the information in the map data, only as much memory as corresponds to the street name is used for the index data for the destination search. This reduces the amount of memory that is used for indexing and makes it possible to perform the destination search at low cost by using the map data. In particular, the map data includes a large amount of information in addition to the data required for the search, and if such map data is used for the search, the possibility arises that the search will be too slow. However, the present invention specifies the area called the parcel, which prevents the speed of the search from being slowed.

In the on-board car navigation destination search device according to the third aspect, index data for the destination search is created in advance by associating with the street name the parcel in which the map data is associated with the area that is bounded by the specified coordinates. The street search portion extracts the parcel in which the street name is located. The node and city area selection portion extracts the city area name that is included in the parcel in which the street name is located, extracts the node name that is included in the parcel that was extracted by the street search portion, extracts the secondary street name that is associated with the node name, and displays the city area name and the secondary street name such that they can be selected.

When the node name is selected by the node and city area selection portion, the node and local area selection portion extracts the city area name that is included in the selected parcel, displays the city area name such that it can be selected, extracts the local area name that is included in the parcel in which the extracted city area name is located, and displays the local area name such that it can be selected, thus making it possible to specify a node name for which no house number is provided.

Further, when the city area name is selected by the node and city area selection portion, the local area, and house number selection portion extracts and displays the local area name that is included in the extracted parcel and specifies the house number within the parcel in which the extracted local area name is located, thus making it possible to specify an individual home.

At this time, it is possible to limit the index data for the destination search simply by associating with the street name the parcel in which the map data is associated with the area that is bounded by the specified coordinates. Because it is possible to select the destination based on the information in the map data in addition to the index data, only as much memory as corresponds to the street name is used for the index data for the destination search. This reduces the amount of memory that is used for indexing and makes it possible to perform the destination search at low cost by using the map data. In particular, the map data includes a large amount of information in addition to data required for the search, and if such map data is used for the search, the possibility arises that the search will be too slow. However, the present invention specifies the area called the parcel, which prevents the speed of the search from being slowed.

In the on-board car navigation destination search method according to the fourth aspect, index data for the destination search is created in advance by associating with the street name the parcel in which the map data is associated with the area that is bounded by the specified coordinates. In the method, the parcel in which the street name is located is then extracted, the city area name that is included in the parcel in which the street name is located is extracted and displayed such that it can be selected, the local area name that is included in the parcel in which the city area name is located is extracted and displayed such that it can be selected, and the house number is specified within the parcel in which the local area name is located. It is thus possible to specify an individual home by specifying the house number.

At this time, it is possible to limit the index data for the destination search simply by associating with the street name the parcel in which the map data is associated with the area that is bounded by the specified coordinates. Because it is possible to select the destination based on the information in the map data in addition to the index data, only as much memory as corresponds to the street name is used for the index data for the destination search. This reduces the amount of memory that is used for indexing and makes it possible to perform the destination search at low cost by using the map data. In particular, the map data includes a large amount of information in addition to the data required for the search, and if such map data is used for the search, the possibility arises that the search will be too slow. However, the present invention specifies the area called the parcel, which prevents the speed of the search from being slowed.

In the on-board car navigation destination search method according to the fifth aspect, index data for the destination search is created in advance by associating with the street name the parcel in which the map data is associated with the area that is bounded by the specified coordinates. In the method, the node name that is included in the parcel in which the street name is located is then extracted, the secondary street name that is associated with the node name is extracted and displayed such that the secondary street name that specifies the node name can be selected, the city area name that is included in the parcel in which the node name is located is extracted and displayed such that it can be selected, the local area name that is included in the parcel in which the city area name is located is extracted and displayed such that it can be selected, thus making it possible to specify a node name for which no house number is provided.

At this time, it is possible to limit the index data for the destination search simply by associating with the street name the parcel in which the map data is associated with the area that is bounded by the specified coordinates. Because it is possible to select the destination based on the information in the map data in addition to the index data, only as much memory as corresponds to the street name is used for the index data for the destination search. This reduces the amount of memory that is used for indexing and makes it possible to perform the destination search at low cost by using the map data. In particular, the map data includes a large amount of information in addition to the data required for the search, and if such map data is used for the search, the possibility arises that the search will be too slow. However, the present invention specifies the area called the parcel, which prevents the speed of the search from being slowed.

In the on-board car navigation destination search method according to the sixth aspect, index data for the destination search is created in advance by associating with the street name the parcel in which the map data is associated with the area that is bounded by the specified coordinates. In the method, the parcel in which the street name is located is then extracted, the city area name that is included in the parcel in which the street name is located is extracted and displayed, the node name that is included in the parcel in which the street name is located is extracted, and the secondary street name that is associated with the node name is extracted and displayed, such that the city area name and the secondary street name can be selected. When the node name is selected, the city area name that is included in the parcel in which the node name is located is extracted and displayed such that it can be selected, the local area name that is included in the parcel in which the city area name is located is extracted, and the local area name is displayed such that it can be selected, thus making it possible to specify an intersection (a node name) for which no house number is provided. Further, when the city area name is selected, the local area name that is included in the parcel in which the city area name is located is extracted, and the house number is specified within the parcel in which the extracted local area name is located, thus making it possible to specify an individual home.

In particular, according to the present invention, the ability to specify the individual home by specifying the house number within the parcel in which the local area name is located, as well as the selecting of the local area name that is included in the parcel in which the specified node name is located, makes it possible to specify the node name for which no house number is provided.

At this time, it is possible to limit the index data for the destination search simply by associating with the street name the parcel in which the map data is associated with the area that is bounded by the specified coordinates. Because it is possible to select the destination based on the information in the map data in addition to the index data, only as much memory as corresponds to the street name is used for the index data for the destination search. This reduces the amount of memory that is used for indexing and makes it possible to perform the destination search at low cost by using the map data. In particular, the map data includes a large amount of information in addition to the data required for the search, and if such map data is used for the search, the possibility arises that the search will be too slow. However, the present invention specifies the area called the parcel, which prevents the speed of the search from being slowed.

In the on-board car navigation destination search device according to any one of the first to the third aspects, as well as the on-board car navigation destination search method according to any one of the fourth to the sixth aspects, the city area is one of a prefecture in the case of Japan and a state and an urban area in the case of the United States. In addition to the effects described in any one of the first to the third aspects and in any one of the fourth to the sixth aspects, this makes the actual operation more closely resemble an address display, making the device and the method feel more familiar.

In the on-board car navigation destination search device according to any one of the first to the third aspects, as well as the on-board car navigation destination search method according to any one of the fourth to the sixth aspects, the local area is one of a county, a city, a town, and a village in the case of Japan, and a smaller city and a town area in the case of the United States. In addition to the effects described in any one of the first to the third aspects and in any one of the fourth to the sixth aspects, this makes the actual operation more closely resemble an address display, making the device and the method feel more familiar.

### BRIEF DESCRIPTION OF THE DRAWINGS

FIG. 1 is a block diagram that shows an overall configuration that functionally describes an on-board car navigation destination search device according to a first embodiment of the present invention;

FIG. 2 is a flowchart of an address search by the on-board car navigation destination search device according to the first embodiment of the present invention;

FIG. 3 is a street search data map that shows correspondence relationships between street names and parcels and that is used by the on-board car navigation destination search device according to the first embodiment of the present invention;

FIG. 4 is an explanatory figure of parcels in the on-board car navigation destination search device according to the first embodiment of the present invention;

FIG. 5 is an explanatory figure of city area data in the on-board car navigation destination search device according to the first embodiment of the present invention;

FIG. 6 is a block diagram that shows an overall configuration that functionally describes an on-board car navigation destination search device according to a second embodiment of the present invention;

FIG. 7 is a flowchart of an address search by the on-board car navigation destination search device according to the second embodiment of the present invention;

FIG. 8 is an explanatory figure that shows relationships between secondary street names and city areas in the on-board car navigation destination search device according to the second embodiment of the present invention;

FIG. 9 is an explanatory figure of parcels in the on-board car navigation destination search device according to the second embodiment of the present invention;

FIG. 10 is a block diagram that shows an overall configuration that functionally describes an on-board car navigation destination search device according to a third embodiment of the present invention; and

FIG. 11A and FIG. 11B, respectively, is a flowchart of an address search by the on-board car navigation destination search device according to the third embodiment of the present invention.

### DETAILED DESCRIPTION OF THE EMBODIMENTS

Hereinafter, embodiments of the present invention will be explained based on the drawings. Note that functional portions that are identical or equivalent among the embodiments are denoted by the same symbols and the same reference numerals in the drawings and the embodiments, and duplicate explanations will be omitted.

### First Embodiment

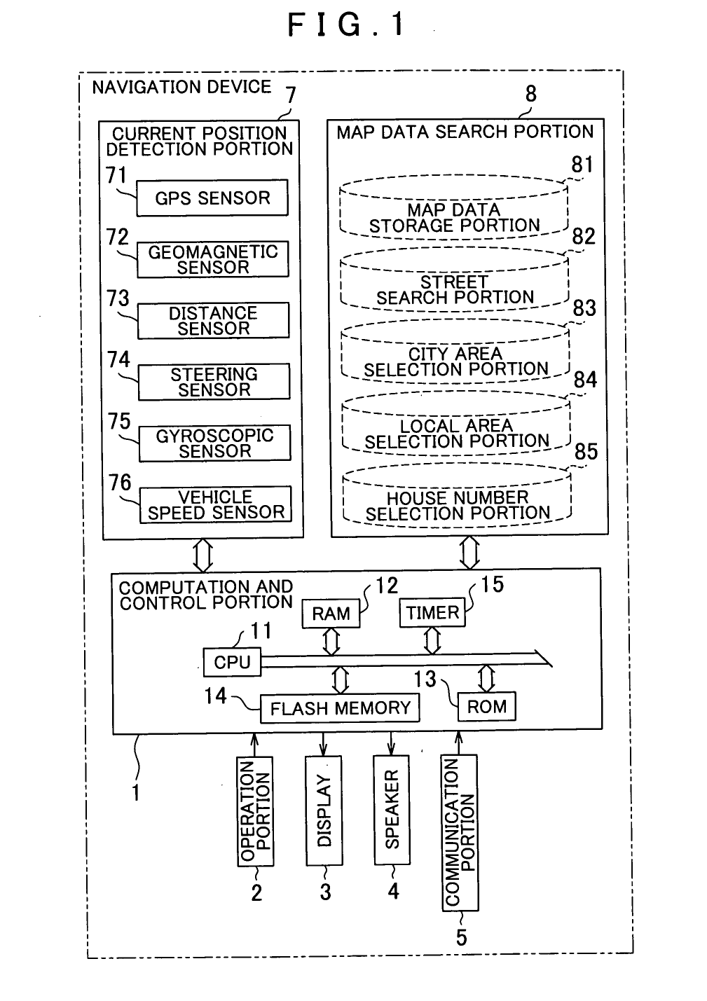

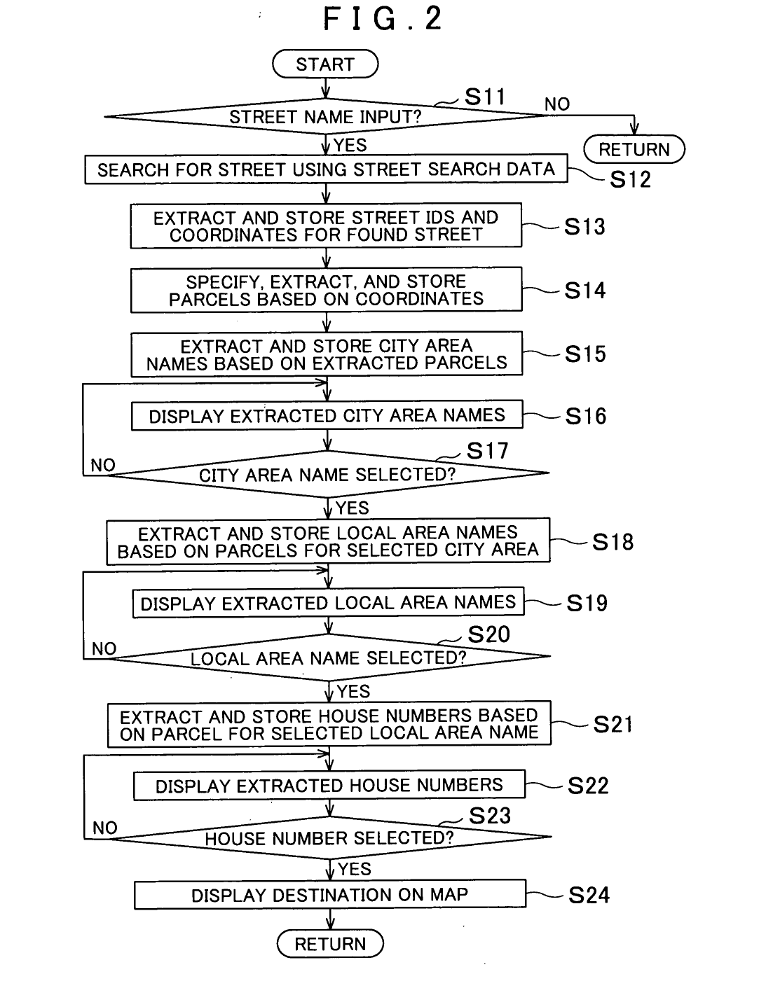

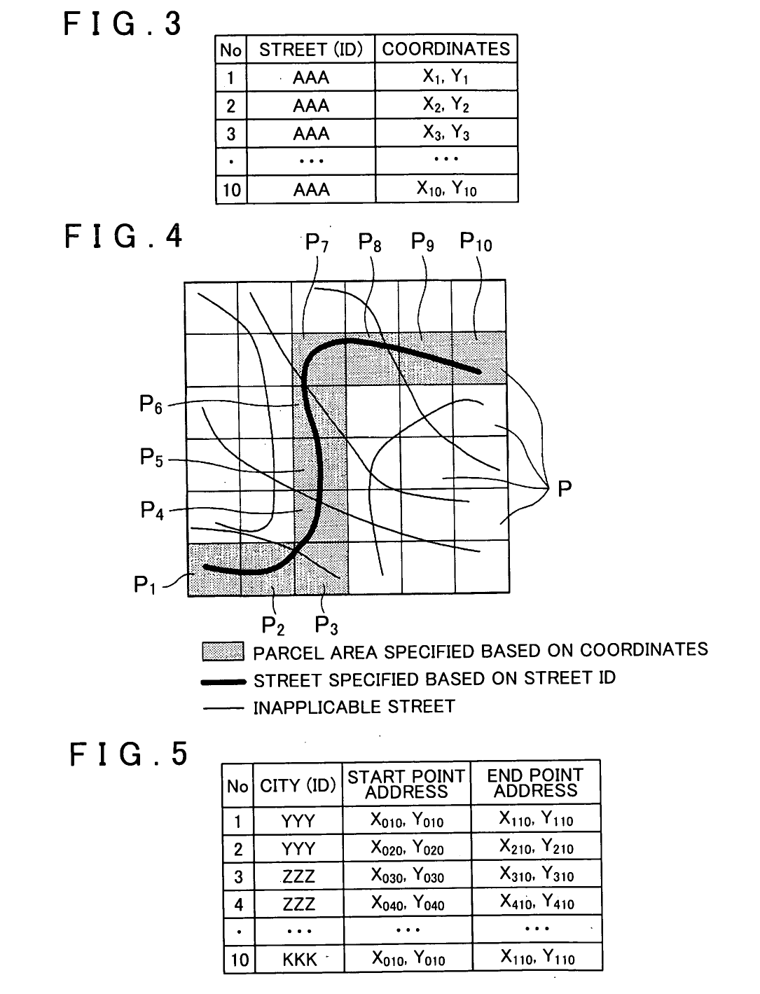

FIG. 1 is a block diagram that shows an overall configuration that functionally describes an on-board car navigation destination search device according to a first embodiment of the present invention, and FIG. 2 is a flowchart of an address search by the on-board car navigation destination search device according to the first embodiment of the present invention. FIG. 3 is a street search data map that shows correspondence relationships between street names and parcels and that is used by the on-board car navigation destination search device according to the first embodiment of the present invention. FIG. 4 is an explanatory figure of parcels in the on-board car navigation destination search device according to the first embodiment of the present invention. FIG. 5 is an explanatory figure of city area data in the on-board car navigation destination search device according to the first embodiment of the present invention.

In FIG. 1, an on-board car navigation destination search device according to the first embodiment includes a computation and control portion 1, an operation portion 2, a display 3, a speaker 4, and the like. The computation and control portion 1 is configured from a microprocessor that performs various types of computational processing based on information that is input. The operation portion 2 includes various types of key inputs, audio inputs, touch switches, and the like that accept operations by an operator such as a driver. The display 3 is configured from a liquid crystal display that displays operation information for the operator, information on maps and the like, map data write information, and the like. The speaker 4 executes voice guidance in connection with route guidance. Note that a keyboard, a mouse, a bar code reader, a remote control device for remote operation, or the like may be used for the operation portion 2, and the operation portion 2 may also be configured from a touch panel that is provided on the front face of the display 3.

The computation and control portion 1 that is configured from the microprocessor includes a CPU 11, a RAM 12, a ROM 13, an internal storage device such as a flash memory 14, a timer 15, and the like. The CPU 11 performs overall computation and control. The RAM 12 stores data and the like and is used as a working memory for various types of computational processing that the CPU 11 performs. The ROM 13 stores a control program and the like. The internal storage device such as the flash memory 14 stores a program that is read from the ROM 13. The timer 15 measures time.

Various types of programs are stored in the ROM 13, and various types of data are written to the RAM 12. Programs, data, and the like are read from an external storage device, a memory card, or the like and are written to the flash memory 14. In addition, the programs, data, and the like can be updated by replacing the memory card or the like, as well as by installing specified programs, data, and the like from an external source.

Various peripheral devices, such as the operation portion 2, the display 3, the speaker 4, and a communication portion 5, are electrically connected to the computation and control portion 1. The operation portion 2 is configured from operation switches, such as various types of keys, that are operated in order to perform a search when a departure point is input as a guidance start point and a destination is input as a guidance end point. Based on switch signals that are output by operating the various switches in the operation portion 2, the computation and control portion 1 performs control to execute various types of operations that correspond to the signals.

Operation guidance, an operation menu, key guidance, and the like are displayed on the display 3. Note that instead of the liquid crystal display, a CRT display, a plasma display, an EL, and the like can be used for the display 3, and a hologram device that projects a hologram onto a vehicle's front windshield or the like can also be used. The display 3 may also display touch switches that serve as the operation portion 2. Based on commands from the computation and control portion 1, the speaker 4 outputs voice guidance that provides route guidance and guidance to changes in the route. Note that in addition to a synthesized voice that is output as a voice by the speaker 4, various types of sound effects and various types of guidance information that is recorded in advance in memory or the like may also be output as a voice by the speaker 4.

In Japan, the communication portion 5 may also be provided to perform communication with information centers such as the Japan Road Traffic Information Center (hereinafter simply called JARTIC (registered trademark)) and the Vehicle Information and Communication System (hereinafter simply called VICS (registered trademark)) Center, as necessary. The communication portion 5 may also be configured to perform wireless communication with wireless base stations, such as a wireless LAN for performing wireless communication, the ETC (registered trademark) that is used in Intelligent Transportation Systems (ITS), and the DSRC that is used for regional information.

A current position detection portion 7 that detects the current position of the vehicle is configured from a GPS sensor 71, a geomagnetic sensor 72, a distance sensor 73, a steering sensor 74, a gyroscopic sensor 75, a vehicle speed sensor 76, and the like. The gyroscopic sensor 75 serves as a heading sensor, and the vehicle speed sensor 76 detects the vehicle's speed and the distance that the vehicle has traveled. Note that the distance sensor 73 and the vehicle speed sensor 76 may be implemented in a single unit.

In the present embodiment, in particular, only the GPS sensor 71 is used, and it can serve as the current position detection portion 7. The GPS sensor 71 detects the current position of the vehicle on the Earth and the distance the vehicle has traveled by receiving radio waves from artificial satellites. The geomagnetic sensor 72 detects the vehicle's heading by measuring geomagnetism. The distance sensor 73 detects distances between specified locations on the road and the like. The distance sensor 73 may, for example, detect the revolution speed of the vehicle's wheels and compute the distance based on the measured revolution speed, but the distance may also be detected by integrating the output of the vehicle speed sensor 76.

The steering sensor 74 detects the steering angle of the vehicle. For example, an optical rotation sensor that is attached to a rotating portion of the steering wheel, a rotation resistance sensor, and an angle sensor that is attached to a wheel of the vehicle may be used for the steering sensor 74.

The gyroscopic sensor 75 detects the turning angle of the vehicle. For example, a gas rate gyroscope, a vibration gyroscope, or the like may be used for the gyroscopic sensor 75. The vehicle's heading may also be detected by integrating the turning angle that is detected by the gyroscopic sensor 75.

A map data search portion 8 in the first embodiment is configured as described below.

A map data storage portion 81 contains commercially available maps, as well as graphic data that adds explanations to the maps. In the present embodiment, the map data storage portion 81 ordinarily contains conceptual information on prefectures in the case of Japan, and on states and urban areas in the case of the United States, as city area information, conceptual information on counties, cities, towns, and villages in the case of Japan, and on smaller city and town areas in the case of the United States, as local area information, and conceptual information on expressways, national routes, and prefectural routes in the case of Japan, and on main streets, secondary streets, and the like in the case of the United States, as street name (road name) information. The map data storage portion 81 also contains, as node name information, information on intersections where roads intersect. All of this information is called map data in this specification.

A street search portion 82 serves as an index data portion in which the parcels that are associated with areas that are bounded by specified coordinates are associated with street names. When a street name is input, the street search portion 82 extracts the parcels P in which the street name is located (P indicates unspecified parcels). Specifically, as shown in FIG. 3, when the street name is input, the street search portion 82 associates the street (a street ID) with specific coordinates (X1, . . . , Y1, . . . ) that indicate the parcels P. That is, each of the parcels P has a specific area, and the specific coordinates (X1, Y1) are used to define the parcel P as a two-dimensional space by specified length and breadth of the parcel P.

In FIG. 3, when a street name is input, the street is specified as “AAA”, and the parcels P in which the street is located are selected based on the coordinates. For example, as shown in FIG. 4, the street in question starts in a parcel P1, passes through a parcel P2, a parcel P3, and so on through a parcel P9, until the street ends in a parcel P10. Therefore, the parcels P1 to P10, where the street that is specified by the street name is located, are specified.

A city area selection portion (a first city area selection portion) 83 extracts city area data that is included in the parcels P1 to P10, where the street that was selected by the street search portion 82 is located. A search is performed for the conceptual information, on prefectures in the case of Japan, and on states and urban areas in the case of the United States, in the map data for each of the parcels P1 to P10. The city area data is extracted and displayed, such that it is provided as the data for the city area that the user has selected.

In concrete terms, as shown in FIG. 5, the city area is specified by city (ID) information and is specified as the city area (the city) within which the selected parcels P are located, based on start point addresses and end point addresses for the parcels P that are associated with the specified street.

A local area selectidn portion (a first local area selection portion) 84 extracts and displays names of local areas that are included in the specified ones of the parcels P1 to P10 where the city area that was selected by the city area selection portion 83 is located. The local area names are displayed such that they can be selected. A search is performed for the conceptual information, on counties, cities, towns, and villages in the case of Japan, and on smaller city and town areas in the case of the United States, in the map data for each of the parcels P1 to P10. The local area data is extracted and displayed, such that it is provided as the data for the local area that the user has selected.

A house number selection portion 85 extracts and displays house numbers that are included in the specified ones of the parcels P1 to P10 where the local area name that was selected by the local area selection portion 84 is located. The house numbers are displayed such that they can be selected. Note that the house number in the case of the United States, and the chome, the banchi, and the apartment number in the case of Japan, may also be input manually, without being extracted from a portion of the selected parcels P1 to P10.

Next, the flowchart for the on-board car navigation destination search device according to the first embodiment of the present invention will be explained using FIG. 2.

This routine is called by a main program of the on-board car navigation device. First, at step S11, the processing for the routine starts when a street name is input. At step S12, the input street name is searched using street search data, and at step S13, a street name (ID) and the coordinates for the parcels P that correspond to the street name that is found are extracted and stored. At step S14, the parcels P in which the road with the specified street name is located, starting in the parcel P1, passing through the parcel P2, the parcel P3, and so on through the parcel P9, until the road ends in the parcel P10, for example, are extracted and stored based on the street name and the coordinates.

At step S15, the city area names are extracted from the extracted parcels P1 to P10 and stored, and at step S16, at least one of the extracted city names is displayed. Assume, for example, that the parcels P4 and P5 have been extracted. At step S17, a specified city area name is alternatively selected from among the displayed city area names. At step S18, at least one local area name is extracted and stored from among the parcels P4 and P5 that are common to the selected city area.

At step S19, at least one of the extracted local area names is displayed. At step S20, a specified local area name is alternatively selected from among the at least one displayed local area name.

At step S21, a search is performed for the house numbers with respect to the selected local area name, for example, in the parcel P5, and the house numbers are extracted and stored. At step S22, the house numbers that have been found in the parcel P5 are displayed, and when one of the house numbers is selected at step S23, a map that includes that location as the destination is displayed at step S24.

Therefore, because each individual home can be specified by the house number, it is possible to limit the index data for the destination search simply by associating the street name with the parcels P in each of which the map data is associated with the area that is bounded by the specified coordinates. Because it is possible to search for the destination based on the information in the map data in addition to the index data, only as much the memory as corresponds to the street names is used for the index data for the destination search. This reduces the amount of memory that is used for indexing and makes it possible to perform the destination search at low cost by using the map data.

### Second Embodiment

In the embodiment that is described above, each individual home is specified by the house number, but the present invention may be implemented by the configuration that is described below when an intersection or the like is specified.

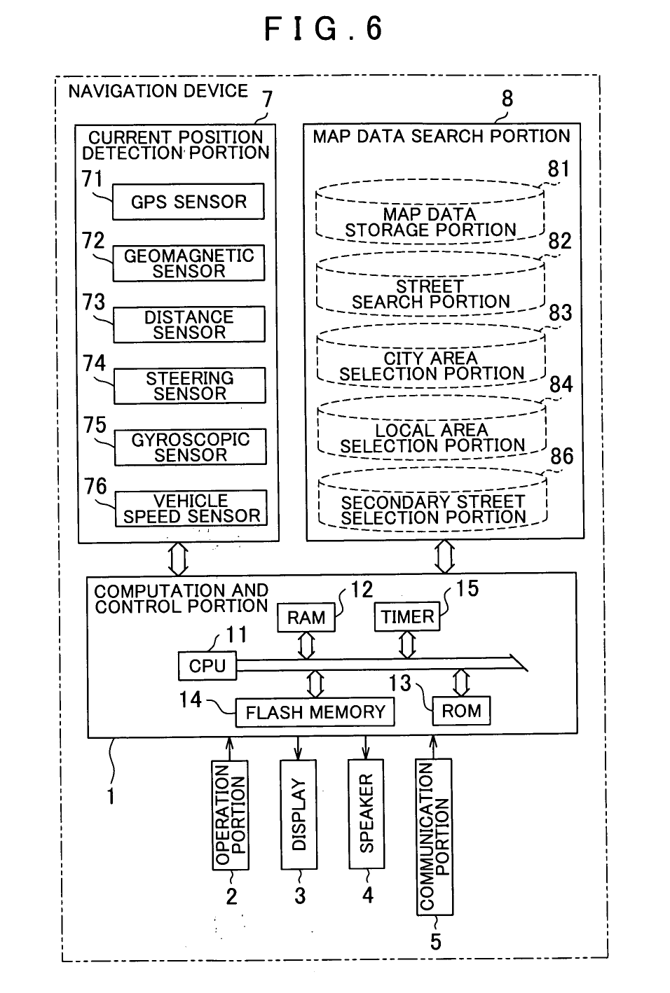

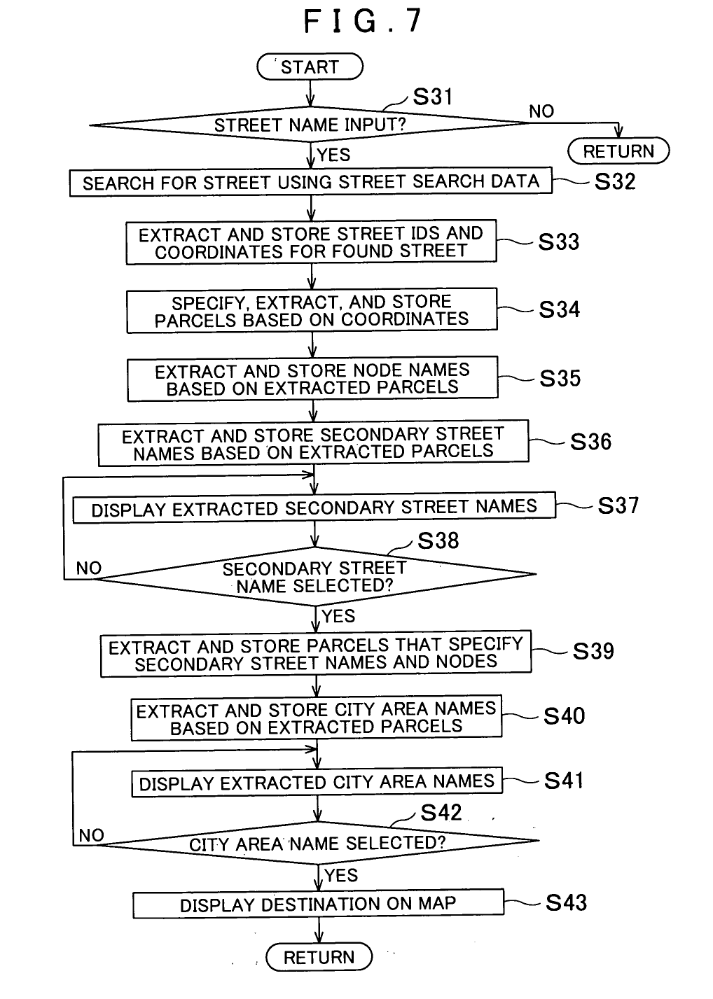

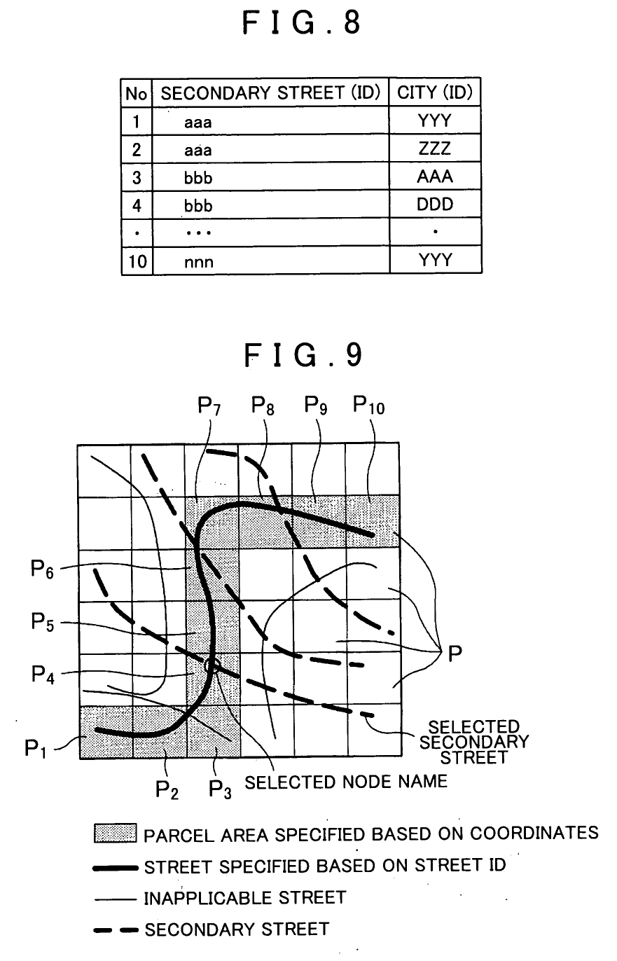

FIG. 6 is a block diagram that shows an overall configuration that functionally describes an on-board car navigation destination search device according to a second embodiment of the present invention, and FIG. 7 is a flowchart of an address search by the on-board car navigation destination search device according to the second embodiment of the present invention. FIG. 8 is an explanatory figure that shows relationships between secondary street names and city areas in the on-board car navigation destination search device according to the second embodiment of the present invention. FIG. 9 is an explanatory figure of parcels in the on-board car navigation destination search device according to the second embodiment of the present invention.

Note that the present embodiment also uses the street search data map of the on-board car navigation destination search device according to the first embodiment of the present invention, which is shown in FIG. 3 and shows correspondence relationships between street names and parcels.

In FIG. 6 of the present embodiment, parcels P in each of which the map data is associated with an area that is bounded by specified coordinates are associated with street names, and when a street name is input, the street search portion 82 extracts the parcels P in which the street name is located, such as the parcels P1 to P10, for example. A secondary street selection portion 86 extracts and displays secondary street names that are included in the parcels P1 to P10 in which is located the street name that has been selected by the street search portion 82. The secondary street selection portion 86 also extracts and displays the names of nodes where the selected street and the secondary streets intersect, displaying the node names such that they can be selected. The parcel P4 is specified by selecting the secondary street name.

The city area selection portion (a second city area selection portion) 83 extracts and displays the names of city areas that are included in the parcels where the node that were selected by the secondary street selection portion 86 is located, such as the parcel P4, for example. The names of the city areas are displayed such that they can be selected. The local area selection portion (a second local area selection portion) 84 extracts and displays the names of local areas that are included in the parcels where the city area that was selected by the city area selection portion 83 is located, such as the parcel P4, for example. The names of the local areas are displayed such that they can be selected.

In concrete terms, as shown in FIG. 8, the information on the city area where the secondary street (ID) is located can be extracted from the map data as city (ID) information.

Next, the flowchart for the on-board car navigation destination search device according to the second embodiment of the present invention will be explained using FIG. 7.

This routine is called by a main program of the on-board car navigation device. First, at step S31, the processing for the routine starts when a street name is input. At step S32, the input street name is searched using street search data, and at step S33, a street name and the coordinates for the parcels P that correspond to the street name that is found are extracted and stored. At step S34, the parcels P in which the road with the specified street name is located, starting in the parcel P1, passing through the parcel P2, the parcel P3, and so on through the parcel P9, until the road ends in the parcel P10, for example, as shown in FIG. 9, are extracted and stored based on the street name and the coordinates.

At step S35, the names of the nodes where the secondary streets intersect the street that was input are extracted from the extracted parcels P1 to P10 and stored. At step S36, the secondary streets are extracted from the extracted parcels P1 to P10 and stored. At step S37, the secondary streets from the extracted parcels P1 to P10 are displayed. At step S38, a specific secondary street name is alternatively selected from among the displayed secondary street names. At step S39, the parcel P4, for example, is selected in accordance with the selected secondary street name and stored.

At step S40, the city area names are extracted from the extracted parcel P4, for example, and stored. At step S41, the extracted city names that have been extracted from the extracted parcel P4, for example, are displayed. When a specified city area name is alternatively selected from among the displayed city area names at step S42, a map that includes the city area as the destination is displayed at step S43.

Therefore, because the intersection can be specified by the node name, it is possible to limit the index data for the destination search simply by associating with the street name the parcels P in each of which the map data is associated with the area that is bounded by the specified coordinates. Because it is possible to search for the destination based on the information in the map data in addition to the index data, only as much memory as corresponds to the street names is used for the index data for the destination search. This reduces the amount of memory that is used for indexing and makes it possible to perform the destination search at low cost by using the map data.

### Third Embodiment

However, in actual practice, the specification of an intersection and the specification of a house number are setting procedures with which the user is not familiar in many cases. In these sorts of cases, it is desirable for the selection to be enabled by a series of selection operations. A third embodiment is an example of this.

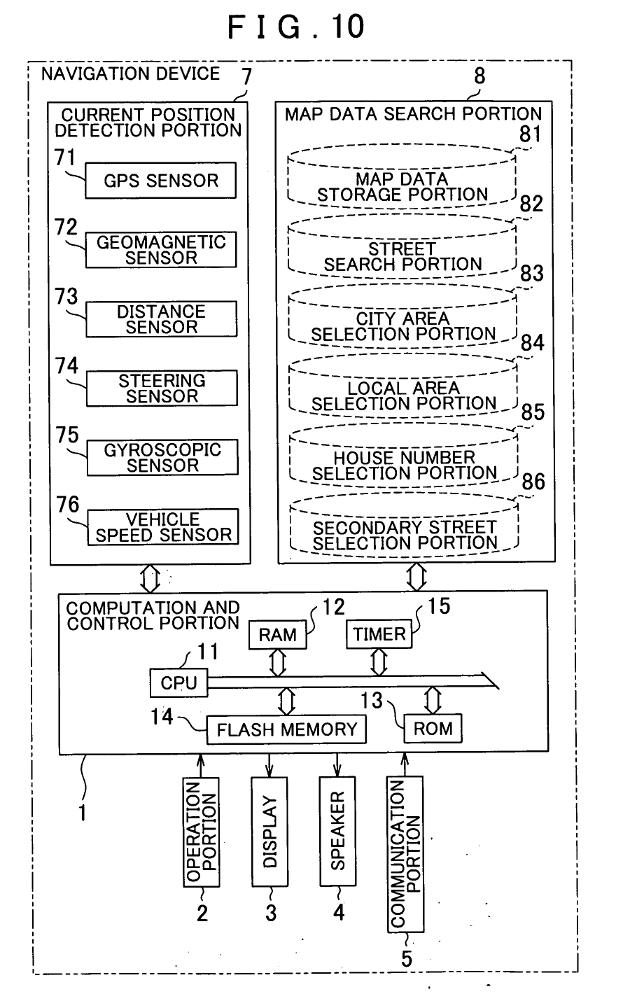

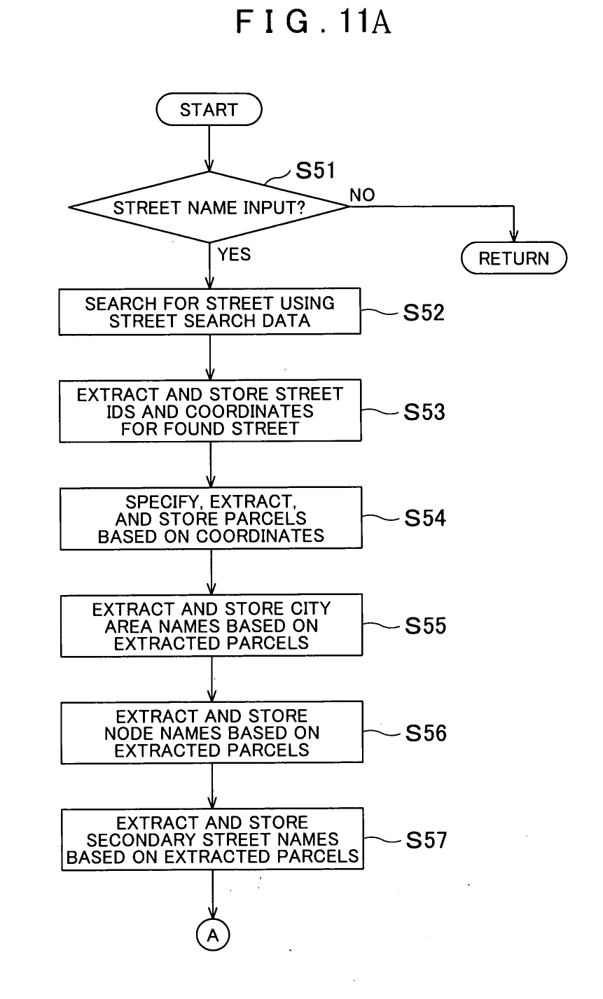

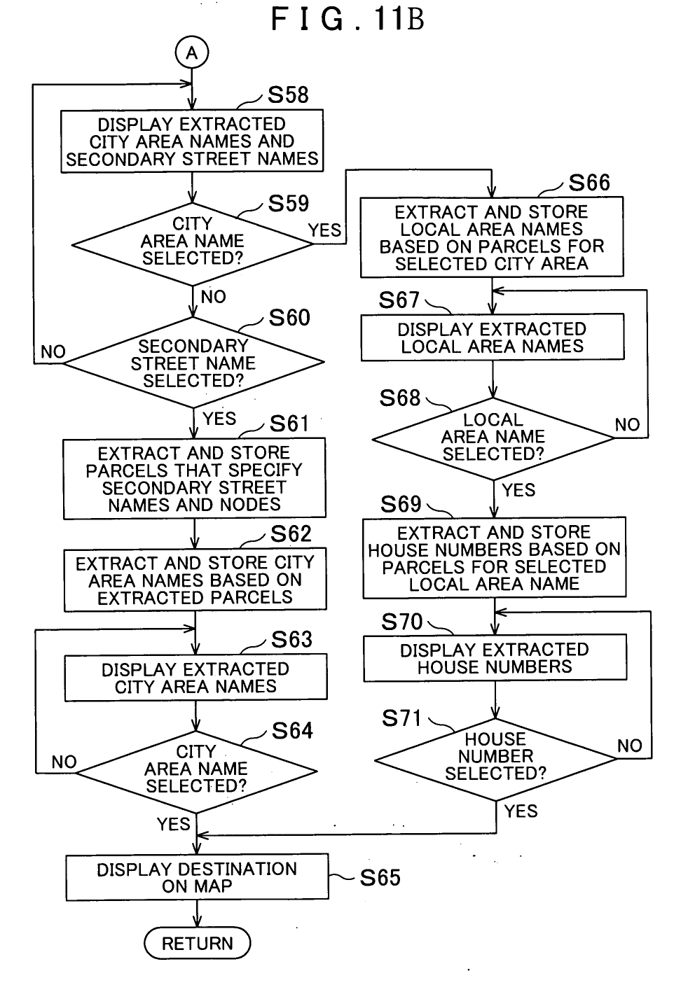

FIG. 10 is a block diagram that shows an overall configuration that functionally describes an on-board car navigation destination search device according to the third embodiment of the present invention, and FIG. 11A and FIG. 11B, respectively, is a flowchart of an address search by the on-board car navigation destination search device according to the third embodiment of the present invention.

In FIG. 10, the point of difference from the first embodiment and the second embodiment is that, in the third embodiment, the secondary street selection portion 86 is added to the configuration of the first embodiment.

In the third embodiment, parcels P in each of which the map data is associated with an area that is bounded by specified coordinates are associated with street names, and when a street name is input, the street search portion 82 extracts the parcels P in which the street name is located.

A node and city area selection portion of the third embodiment, which is configured from the city area selection portion 83 and the secondary street selection portion 86, extracts and displays the names of city areas that are included in the parcels P in which the street name that was selected by the street search portion 82 is located. The node and city area selection portion also extracts the names of nodes that are included in the parcels P in which the street name that was selected by the street search portion 82 is located, then extracts and displays the secondary street names that are associated with the node names. The city area names and the secondary street names are displayed such that they can be selected.

When one of the secondary street names has been selected by the node and city area selection portion, a node and local area selection portion that is configured from the local area selection portion 84 extracts and displays the names of city areas that are included in the parcels P in which the secondary street name is located that was selected by the node and city area selection portion that is configured from the city area selection portion 83 and the secondary street selection portion 86. The city area names are displayed such that they can be selected, and when one of the city area names is selected, the node and local area selection portion extracts and displays the names of local areas that are included in the parcels P in which the selected city area is located. The local area names are displayed such that they can be selected.

When one of the city area names has been selected by the node and city area selection portion, a local area and house number selection portion of the third embodiment that is configured from the house number selection portion 85 extracts and displays the names of local areas that are included in the parcels P in which the city area name is located that was selected by the node and city area selection portion. The local area names are displayed such that they can be selected, and when one of the local area names is selected, the local area and house number selection portion extracts and stores the house numbers that are included in the parcels P in which the selected local area is located. The house numbers are displayed such that they can be selected.

Next, the flowchart for the on-board car navigation destination search device according to the third embodiment of the present invention will be explained using FIG. 11A and FIG. 11B.

This routine is called by a main program of the on-board car navigation device. First, at step S51, the processing for the routine starts when a street name is input. At step S52, the input street name is searched using street search data, and at step S53, a street name (ID) and the coordinates for the parcels P that correspond to the street name that is found are extracted and stored. At step S54, the parcels P in which the road with the specified street name is located, starting in the parcel P1, passing through the parcel P2, the parcel P3, and so on through the parcel P9, until the road ends in the parcel P10, for example, are extracted and stored based on the street name and the coordinates.

At step S55, the city area names are extracted from the extracted parcels P1 to P10 and stored. At step S56, the names of the nodes where the secondary streets intersect the street that was input are extracted from the extracted parcels P1 to P10 and stored. At step S57, the secondary streets are extracted from the extracted parcels P1 to P10 and stored. At step S58, the city area names and the secondary streets are displayed. At step S59, when one of the city area names extracted from the extracted parcels P1 to P10 is alternatively selected, the parcels P in which at least one local area name is located are extracted and stored at step S66 from among a part of the parcels P1 to P10, which is common to the selected city area.

At step S60, when a specific secondary street name is selected from among the displayed secondary street names, a part of the parcels P1 to P10 is selected and stored at step S61 based on the selected second street name.

At step S62, the city area names are extracted from the extracted part of the parcels P1 to P10, and stored. At step S63, the extracted city names that have been extracted from the extracted part of the parcels P1 to P10 are displayed. When a specific city area name is alternatively selected from among the displayed city area names at step S64, a map that includes the city area as the destination is displayed at step S65.

At step S59, when one of the city area names from the extracted parcels P is selected, specific local area names are extracted and stored at step S66 from among the part of the parcels P1 to P10 that is common to the selected city area. At step S67, the extracted local area names are displayed. At step S68, a specific local area name is alternatively selected from among the displayed local area names. The selecting of the local area effectively selects one of the parcels P1 to P10, such as the parcel P5, for example, which is then extracted and stored. At step S69, the house numbers are searched in the parcel P5 with the selected local area name, and the house numbers are extracted and stored. At step S70, the house numbers that have been found in the parcel P5 are displayed, and when one of the house numbers is alternatively selected at step S71, a map that includes that location as the destination is displayed at step S65.

Thus, when the city area names and the secondary streets (the nodes) are selected by the city area selection portion 83 and the secondary street selection portion 86, the on-board car navigation destination search device of the third embodiment that is described above extracts the city area names and the secondary street names that are included in the parcels P that have been selected by the local area selection portion 84, displaying the city area names such that they can be selected. The on-board car navigation destination search device of the third embodiment also extracts the names of the local areas that are included in the parcels where the selected city area name is located, displaying the local area names such that they can be selected. The on-board car navigation destination search device of the third embodiment can thus specify the node names for which no house numbers are provided. Moreover, when the city area name has been selected by the local area selection portion 84, the on-board car navigation destination search device of the third embodiment extracts and displays the names of the local areas that are included in the parcels P that were selected by the house number selection portion 85, and the house number is specified based on the parcel P in which the selected local area name is located, thus making it possible to specify each individual home.

Accordingly, it is possible to limit the index data for the destination search by associating with the street name the parcels P in each of which the map data is associated with the area that is bounded by the specified coordinates. Because it is possible to search for the destination based on the information in the map data in addition to the index data, only as much memory as corresponds to the street names is used for the index data for the destination search. This reduces the amount of memory that is used for indexing and makes it possible to perform the destination search at low cost by using the map data.

As explained above, the on-board car navigation destination search device of the first embodiment, which searches for the route from the vehicle's departure point to the destination and provides route guidance in accordance with the route that has been found, includes the street search portion 82, the city area selection portion (the first city area selection portion) 83, the local area selection portion (the first local area selection portion) 84, and the house number selection portion 85. In the street search portion 82, the parcels P in each of which the map data is associated with the area that is bounded by the specified coordinates are associated with the street names. When the street name is input, the street search portion 82 extracts the parcels P in which the street name is located. The city area selection portion (the first city area selection portion) 83 extracts and displays the names of the city areas that are included in the parcels P in which the street name that was selected by the street search portion 82 is located. The city area names are displayed such that they can be selected. The local area selection portion (the first local area selection portion) 84 extracts and displays the names of the local areas that are included in the parcels P in which the city area that was selected by the city area selection portion (the first city area selection portion) 83 is located. The local area names are displayed such that they can be selected. The house number selection portion 85 specifies the house number within the parcel P in which the local area name that was selected by the local area selection portion (the first local area selection portion) 84 is located.

That is, the on-board car navigation destination search device of the first embodiment that searches for the route from the vehicle's departure point to the destination and provides route guidance in accordance with the route that has been found may be considered as the invention pertaining to an on-board car navigation destination search method that includes the steps of: associating with the street name the parcels P in each of which the map data is associated with the area that is bounded by the specified coordinates and, when the street name is input, extracting the parcels P in which the street name is located; extracting the names of the city areas that are included in the parcels P in which the selected street name is located, and displaying the city area names such that they can be selected; extracting the names of the local areas that are included in the parcels in which the selected city area is located, and displaying the local area names can be selected; and specifying a house number within the parcel in which the selected local area is located.

Accordingly, in the on-board car navigation destination search device according to the first embodiment, the index data for the destination search is created in advance by associating with the street name the parcels P in each of which the map data is associated with the area that is bounded by the specified coordinates, and the street search portion 82 extracts the parcels P in which the street name is located. The city area selection portion (the first city area selection portion) 83 extracts the city areas that are included in the selected parcels P, then displaying the city area names such that they can be selected. The local area selection portion (the first local area selection portion) 84 extracts the names of local areas that are included in the parcels P that were selected by the city area selection portion (the first city area selection portion) 83, then displays the local area names such that they can be selected. Then, the house number selection portion 85 specifies a house number within the parcel P that has been selected by the local area selection portion (the first local area selection portion) 84, thus making it possible to specify an individual home. At this time, it is possible to limit the index data for the destination search simply by associating with the street name the parcels P in each of which the map data is associated with the area that is bounded by the specified coordinates . Because it is possible to search for the destination based on the information in the map data in addition to the index data, only as much memory as corresponds to the street names is used for the index data for the destination search. This reduces the amount of memory that is used for indexing and makes it possible to perform the destination search at low cost by using the map data.

The on-board car navigation destination search device according to the second embodiment explained above, which searches for the route from the vehicle's departure point to the destination and provides route guidance in accordance with the route that has been found, includes the street search portion 82, the secondary street selection portion 86, the city area selection portion (the second city area selection portion) 83, and the local area selection portion (the second local area selection portion) 84. The parcels P in each of which the map data is associated with the area that is bounded by the specified coordinates are associated with the street names. When the street name is input, the street search portion 82 extracts the parcels P in which the street name is located. The secondary street selection portion 86 extracts and displays the names of the secondary streets that are included in the parcels P in which the street name is located that was selected by the street search portion 82. The secondary street selection portion 86 also extracts the names of the nodes where the selected street intersects the secondary streets, and displays the node names such that they can be selected. The city area selection portion (the second city area selection portion) 83 extracts the names of the city areas that are included in the parcels P in which the node name that was selected by the secondary street selection portion is located, and displays the city area names such that they can be selected. The local area selection portion (the second local area selection portion) 84 extracts the names of the local areas that are included in the parcels in which the city area that was selected by the city area selection portion (the second city area selection portion) 83 is located, and displays the local area names such that they can be selected.

The on-board car navigation destination search device according to the second embodiment explained above, which searches for the route from the vehicle's departure point to the destination and provides route guidance in accordance with the route that has been found, may be considered as the invention pertaining to an on-board car navigation destination search method that includes the steps of: associating with the street name the parcels P in each of which the map data is associated with the area that is bounded by the specified coordinates, and, when the street name is input, extracting the parcels P in which the street name is located; extracting and displaying the names of the secondary streets that are included in the parcels P in which the selected street name is located, extracting the names of the nodes where the selected street intersects the secondary streets, and displaying the node names such that they can be selected; extracting the names of the city areas that are included in the parcels in which the node names are located, and displaying the city area names such that they can be selected; and extracting the names of the local areas that are included in the parcels in which the city areas are located, and displaying the local area names such that they can be selected.

Accordingly, in the on-board car navigation destination search device according to the second embodiment, the index data for the destination search is created in advance by associating with the street name the parcels P in each of which the map data is associated with the area that is bounded by the specified coordinates. The street search portion 82 then extracts the parcels P in which the street name is located. The secondary street selection portion 86 extracts the names of the secondary streets that are included in the parcels P that were selected by the street search portion 82. The secondary street selection portion 86 also extracts the names of the nodes where the selected street intersects the secondary streets based on the selected street name and the secondary street names, and displays the node names such that they can be selected. The city area selection portion (the second city area selection portion) 83 extracts the city area names that are included in the parcels P that were selected by the secondary street selection portion 86, and displays the city area names such that they can be selected. The local area selection portion (the first local area selection portion) 84 extracts the local area names that are included in the parcels P that were selected by the city area selection portion (the second city area selection portion) 83, and then displays the local area names such that they can be selected, thus making it possible to specify the intersections (nodes) for which no house numbers are provided.

At this time, it is possible to limit the index data for the destination search simply by associating with the street name the parcels in each of which the map data is associated with the area that is bounded by the specified coordinates. Because it is possible to search for the destination based on the information in the map data in addition to the index data, only as much memory as corresponds to the street names is used for the index data for the destination search. This reduces the amount of memory that is used for indexing and makes it possible to perform the destination search at low cost by using the map data.

The on-board car navigation destination search device according to the third embodiment explained above, which searches for the route from the vehicle's departure point to the destination and provides route guidance in accordance with the route that has been found, includes the street search portion 82, the node and city area selection portion, the node and local area selection portion, and the local area and house number selection portion. The parcels in each of which the map data is associated with the area that is bounded by the specified coordinates are associated with the street name. The street search portion 82 extracts the parcels when the street name is input. The node and city area selection portion is configured from the city area selection portion 83 and the secondary street selection portion 86. The node and city area selection portion extracts and displays the names of the city areas that are included in the parcels P in which the street name that was selected by the street search portion 82 is located. The node and city area selection portion also extracts the names of the nodes that are included in the parcels P in which the street name that was selected by the street search portion 82 is located, then extracts and displays the secondary street names that are associated with the node names. The node and city area selection portion displays the city area names and the secondary street names such that they can be selected. The node and local area selection portion is configured from the local area selection portion 84. When one of the secondary street names has been selected by the node and city area selection portion that is configured from the city area selection portion 83 and the secondary street selection portion 86, the node and local area selection portion extracts and displays the names of the city areas that are included in the parcels P in which the secondary street name is located that was selected by the node and city area selection portion configured from the city area selection portion 83 and the secondary street selection portion 86. The city area names are displayed such that they can be selected. When one of the city area names is selected, the node and local area selection portion extracts and displays the names of the local areas that are included in the parcels P in which the selected city area is located. The local area names are displayed such that they can be selected. The local area and house number selection portion is configured from the house number selection portion 85. When one of the city area names has been selected by the node and city area selection portion that is configured from the city area selection portion 83 and the secondary street selection portion 86, the local area and house number selection portion extracts and displays the names of the local areas that are included in the parcels in which the city area name is located that was selected by the node and city area selection portion that is configured from the city area selection portion 83 and the secondary street selection portion 86. The local area names are displayed such that they can be selected. When one of the local area names is selected, the local area and house number selection portion specifies the house numbers that are included in the parcels in which the selected local area is located.

The on-board car navigation destination search device according to the third embodiment explained above, which searches for the route from the vehicle's departure point to the destination and provides route guidance in accordance with the route that has been found, may be considered as the invention pertaining to a on-board car navigation destination search method that includes the steps of: associating with the street name the parcels P in each of which the map data is associated with the area that is bounded by the specified coordinates, and, when the street name is input, extracting the parcels P in which the street name is located; extracting and displaying the names of the city areas that are included in the parcels P in which the street name is located, extracting the names of the nodes that are included in the parcels P in which the street name is located, and also extracting the names of the secondary streets that are associated with the node names, and displaying the city area names and the secondary street names such that they can be selected; extracting, when one of the secondary street names has been selected, the names of the city areas that are included in the parcels P in which the secondary street name is located, displaying the city area names such that they can be selected, extracting the names of the local areas that are included in the parcels in which the city area name is located, and displaying the local area names such that they can be selected; and extracting, when one of the city area names has been selected, the names of the local areas that are included in the parcels P in which the city area name is located, displaying the local area names such that they can be selected, and specifying the house number within the parcel in which the selected local area is located.

Accordingly, in the on-board car navigation destination search device according to the third embodiment, the index data for the destination search is created in advance by associating with the street name the parcels P in each of which the map data is associated with the area that is bounded by the specified coordinates. The street search portion 82 extracts the parcels P in which the street name is located. The node and city area selection portion, which is configured from the city area selection portion 83 and the secondary street selection portion 86, extracts the secondary street names in the parcels P that were selected by the street search portion 82, and also extracts the names of the nodes where the secondary streets intersect the input street that are included in the selected parcels P, and displays the node names such that they can be selected. The node and city area selection portion also extracts the names of the city areas that are included in the parcels P in which the street name that was selected by the street search portion 82 is located, and displaying the city area names such that they can be selected.

When one of the node names has been selected by the node and city area selection portion that is configured from the city area selection portion 83 and the secondary street selection portion 86, the node and local area selection portion that is configured from the local area selection portion 84 extracts the names of the city areas that are included in the parcel P where the selected node name is located and displays the city area names such that they can be selected. The node and local area selection portion also extracts the names of the local areas that are included in the parcels P where the selected city area name is located and displays the local area names such that they can be selected. This makes it possible to specify the node names for which no house numbers are provided. When one of the city area names is selected by the node and city area selection portion that is configured from the city area selection portion 83 and the secondary street selection portion 86, the node and local area selection portion that is configured from the local area selection portion 84 extracts and displays the names of the local areas that are included in the selected parcels P and specifies the house number within the parcel in which the selected local area name is located, thus making it possible to specify each individual home.

At this time, it is possible to limit the index data for the destination search simply associating with the street name the parcels P in each of which the map data is associated with the area that is bounded by the specified coordinates. Because it is possible to search for the destination based on the information in the map data in addition to the index data, only as much memory as corresponds to the street names is used for index data for the destination search. This reduces the amount of memory that is used for indexing and makes it possible to perform the destination search at low cost by using the map data.

The on-board car navigation destination search device and the on-board car navigation destination search method in the embodiments described above have been explained using the concept of the city area, but the device and the method may also be explained using the concepts of prefectures and cities in the case of Japan, and the concepts of states and urban areas in the case of the United States. For the local areas, the concepts of counties, cities, towns, and villages in the case of Japan, and smaller city and town areas in the case of the United States, may also be used. Any administrative district concept may be used.

Streets have been explained in terms of the concepts of streets (main streets), secondary streets, and the like, but in a case where the present invention is practiced in Japan, the concept of the national route may be used for expressways, and the concepts of the prefectural route and the city street may be used for secondary streets.

What is claimed is:

1. An on-board car navigation destination search device that searches for a route from a departure point to a destination and provides guidance in accordance with the route that is found, comprising:
a street search portion that associates with a street name a parcel in which map data is associated with an area that is bounded by specified coordinates and, when the street name is input, extracts the parcel in which the street name is located;
a first city area selection portion that extracts a city area name in the extracted parcel, and displays the city area name such that the city area name can be selected;
a first local area selection portion that extracts a local area name that is included in the parcel in which the selected city area name is located, and displays the local area name such that the local area name can be selected; and
a house number selection portion that specifies a house number within the parcel in which the selected local area name is located.

2. An on-board car navigation destination search device that searches for a route from a departure point to a destination and provides guidance in accordance with the route that is found, comprising:
a street search portion that associates with a street name a parcel in which map data is associated with an area that is bounded by specified coordinates and, when the street name is input, extracts the parcel in which the street name is located;
a secondary street selection portion that extracts a node name in the extracted parcel, extracts a secondary street name that is associated with the node name, and displays the secondary street name that specifies the node name such that the node name can be selected;
a second city area selection portion that extracts a city area name in the parcel in which the selected node name is located, and displays the city area name such that the city area name can be selected; and
a second local area selection portion that extracts a local area name in the parcel in which the selected city area name is located, and displays the local area name such that the local area name can be selected.

3. An on-board car navigation destination search device that searches for a route from a departure point to a destination and provides guidance in accordance with the route that is found, comprising:
a street search portion that associates with a street name a parcel in which map data is associated with an area that is bounded by specified coordinates and, when the street name is input, extracts the parcel in which the street name is located;
a node and city area selection portion that extracts a city area name and a node name in the extracted parcel, extracts a secondary street name that is associated with the node name, and displays the city area name and the secondary street name such that the city area name or the secondary street name can be selected;
a node and local area selection portion that, when the secondary street name is selected, extracts a city area name in the parcel in which the selected secondary street name is located, displays the city area name such that the city area name can be selected, extracts a local area name in the parcel in which the selected city area name is located, and displays the local area name such that the local area name can be selected; and
a local area and house number selection portion that, when the city area name is selected, extracts a local area name in the parcel in which the selected city area name is located, displays the local area name such that the local area name can be selected, and specifies a house number within the parcel in which the selected local area name is located.

4. An on-board car navigation destination search method that searches for a route from a departure point to a destination and provides guidance in accordance with the route that is found, comprising the steps of:
associating with a street name a parcel in which map data is associated with an area that is bounded by specified coordinates and, when the street name is input, extracting the parcel in which the street name is located;
extracting a city area name in the extracted parcel, and displaying the city area name such that the city area name can be selected;
extracting a local area name in the parcel in which the selected city area name is located, and displaying the local area name such that the local area name can be selected; and
specifying a house number within the parcel in which the selected local area name is located.

5. An on-board car navigation destination search method that searches for a route from a departure point to a destination and provides guidance in accordance with the route that is found, comprising the steps of:
associating with a street name a parcel in which map data is associated with an area that is bounded by specified coordinates and, when the street name is input, extracting the parcel in which the street name is located;
extracting a node name in the extracted parcel, extracting a secondary street name that is associated with the node name, and displaying the secondary street name that specifies the node name such that the node name can be selected;
extracting a city area name in the parcel in which the selected node name is located, and displaying the city area name such that the city area name can be selected; and
extracting a local area name in the parcel in which the selected city area name is located, and displaying the local area name such that the local area name can be selected.

6. An on-board car navigation destination search method that searches for a route from a departure point to a destination and provides guidance in accordance with the route that is found, comprising the steps of:
associating with a street name a parcel in which map data is associated with an area that is bounded by specified coordinates and, when the street name is input, extracting the parcel in which the street name is located;
extracting a city area name and a node name in the extracted parcel, extracting a secondary street name that is associated with the node name, and displaying the city area name and the secondary street such that the city area name or the secondary street name can be selected;
extracting, when the secondary street name is selected, a city area name in the parcel in which the selected secondary street name is located, displaying the city area name such that the city area name can be selected, extracting a local area name in the parcel in which the selected city area name is located, and displaying the local area name such that the local area name can be selected; and
extracting, when the city area name is selected, a local area name in the parcel in which the selected city area name is located, and displaying the local area name such that the local area name can be selected, and specifying a house number within the parcel in which the selected local area name is located.

7. The on-board car navigation destination search device according to claim 1,
wherein the city area is one of a prefecture in Japan and a state and an urban area in the United States.

8. The on-board car navigation destination search method according to claim 4,
wherein the city area is one of a prefecture in Japan and a state and an urban area in the United States.

9. The on-board car navigation destination search device according to claim 1,
wherein the local area is one of a county, a city, a town, and a village in Japan, and a smaller city and a town area in the United States.

10. The on-board car navigation destination search method according to claim 4,
wherein the local area is one of a county, a city, a town, and a village in Japan, and a smaller city and a town area in the United States.
